(19) United States
(12) Patent Application Publication
(10) Pub. No.: US 2006/0081816 A1
(43) Pub. Date: Apr. 20, 2006

(54) Material for the production of a conductive organic funtional layer and use thereof

(76) Inventors: Christoph Brabec, Linz (AT); Karsten Heuser, Erlangen (DE); Henning Rost, Erlangen (DE)

Correspondence Address: YOUNG & THOMPSON, 745 SOUTH 23RD STREET, 2ND FLOOR, ARLINGTON, VA, 22202, US

(21) Appl. No.: 10/518,245

(22) PCT Filed: Jun. 12, 2003
(86) PCT No.: PCT/DE03/01954

§ 371 Date: Sep. 1, 2005

(30) Foreign Application Priority Data
Jun. 14, 2002 (DE) 102 26 617.4

(51) Int. Cl. H01B 1/12

(52) U.S. Cl. 252/500

(57) ABSTRACT

The invention relates to a material for a conductive organic functional layer, particularly one based on PEDOT-PSS [poly(3,4-ethylenedioxythiophene)-poly(styrene sulfonate)]. Conductivity is significantly increased by replacing the solvent.

The invention relates to a material for a conductive organic functional layer, particularly one based on PEDOT-PSS [poly(3,4-ethylenedioxythiophene)-poly(styrene sulfonate)].

PEDOT-PSS solutions with different solvents also containing glycol are known, for example, from DE 197 57 542. The disadvantage of these PEDOT-PSS containing materials is that the conductivity has been modified by the admixture of solvent additives or other additives, resulting in disadvantageous effects on the printability of the polymer layers, the conductivity still not having been optimized.

A highly conductive functional polymer is required for organic solar cells, detectors or transistors as well as for organic light emitting diodes on flexible substrates. In the case of the OLEDs and the solar cells, this polymer is used as the anode. For use in organic field effect transistors, said PEDOT can be employed as the material for the source-drain electrodes. ITO (indium tin oxide) is currently employed as an anode material, but due to lack of flexibility (pliability is limited by ceramic structure) it cannot be used on flexible plastic substrates. The conductive properties of the polymer used for this purpose (e.g. PEDOT) should come very close to those of ITO in order to achieve identical component performance characteristics.

ITO has a conductivity in the 10⁴ S/cm region and achieves a surface resistance of 20 ohms/square with a layer thickness of 120 nm. Commercially available PEDOT currently achieves 8 to 10 S/cm from Bayer (or now HC Starck) and 120 S/cm from Agfa (Orgacon film). The PEDOT-PSS dispersions used are currently water-based.

The object of the present invention is therefore to provide a material having an optimized conductivity based on PEDOT-PSS.

The invention is based on the general recognition that replacing the solvent causes the material's conductivity to be increased without adversely affecting processibility, in particular the printability of said material.

The invention relates to a material for producing an organic functional layer based on PEDOT-PSS, wherein conductivity is optimized by replacing the solvent, i.e. substitution of the first solvent by a second solvent.

According to a first embodiment, water or some other strongly polar solvent is used as the “first solvent” to be replaced.

“First solvent” denotes the solvent in which the functional polymer, PEDOT-PSS, is produced. “Second solvent” then accordingly denotes the solvent ultimately present in the material in which the functional polymer exhibits optimized conductivity.

According to one embodiment, a glycol-containing compound such as ethylene glycol or some other alcohol is used as the second solvent, particularly also mixtures of a plurality of alcohols, and/or alcohols with a carbon content of C4 to C10, branched and branched, also multivalent alcohols, or mixtures thereof, as well as mixtures with water, most preferably glycol and glycerol.

The term “organic material” or “functional material” or “functional polymer” here encompasses all types of organic, metal-organic and/or organic-inorganic synthetic materials (hybrids), particularly those known as e.g. “plastics” in English. This includes all types of materials with the exception of the semiconductors forming the conventional diodes (germanium, silicon), and of the typical metallic conductors. Organic material is consequently not to be taken in the dogmatic sense as being restricted to carbon-containing material, but should rather be taken to include also the broad use of e.g. silicones. In addition, the term should not be subject to any limitation in respect of molecule size, in particular of polymeric and/or oligomeric materials, but the use of “small molecules” is also perfectly possible. The “polymer” element in functional polymer is a historical usage and to that extent is not indicative of the presence of an actual polymeric compound and is not indicative as to whether or not a polymer mixture or a copolymer is involved.

The main advantages of the conductive polymer (PEDOT) in ethylene glycol described here is that conductivity is significantly increased by the water being replaced by ethylene glycol. The cause of this increase is not yet clear. On the one hand, it may result in the formation of agglomerates when the solvent is replaced, while on the other hand the attachment of ethylene glycol to the PEDOT/PSS chains may lead to improved current transport due to the formation of hydrogen links.

There are numerous applications for PEDOT in the field of polymer electronics. For example, PEDOT is used as an anode (replacement for ITO) in the field of OLEDs and solar cells on flexible substrates. In this case, the anode can be applied in a directly patterned manner using an existing printing process, the required conductivity approaching that of ITO as closely as possible.

The surprising aspect is that conductivity is increased by two orders of magnitude by replacing the solvent (as e.g. water by ethylene glycol).

The new material can be used with quite outstanding results:
In the field of organic solar cells and transistors, where quite specific requirements are placed on the conductivity of the PEDOT layers which, by means of this invention, can also be met for the various printing processes.
In the field of organic transistors, highly conductive PEDOT is required in order to implement electrical leads or the source-drain electrodes on a polymer basis.
In the field of organic solar cells or detectors, PEDOT is used as an electrode, lead and as a recombination layer for tandem cells.
In the field of electronic components generally for diodes, resistors for IC+ boards

Highly conductive PEDOT can also be used for the two electrodes in a sandwich device (also for inverted construction).

1. Material for producing a conductive organic functional layer based on PEDOT-PSS, wherein the conductivity is optimized by replacing the solvent, i.e. by substitution of a first solvent by a second solvent.

2. Material according to claim 1, wherein the first solvent is water or some other strongly polar solvent.

3. Material according to claim 1, wherein the second solvent is a glycol-containing compound such as ethylene glycol or some other alcohol, in particular also mixtures of a plurality of alcohols, and/or alcohols with a carbon content of C4 to C10, branched and unbranched, also multivalent alcohols, or mixtures thereof, as well as mixtures with water, most preferably glycol and glycerol.

4. Use of a material according to claim 1 for producing an electrode and/or an electrical lead.

5. Use according to claim 4, wherein the material is applied by processing methods such as spin-coating, printing methods such silk screening, inkjet printing, offset, pad printing, flexo print or squeegee methods.

6. Use according to claim 4, wherein the material is applied in a structured manner by a printing process.
